(19) United States
(12) Patent Application Publication
(10) Pub. No.: US 2003/0230371 A1
(43) Pub. Date: Dec. 18, 2003

(54) Method and device for the production of flat ribbon cables

(76) Inventor: Bernd Pielsticker, Sarstedt (DE)

Correspondence Address: LACKENBACH SIEGEL LLP, One Chase Road, Scarsdale, NY, 10583, US

(21) Appl. No.: 10/396,149

(22) Filed: Mar. 25, 2003

(30) Foreign Application Priority Data
Mar. 26, 2002 (DE) 102 13 736.6-34

(51) Int. Cl. H01B 7/08; H01B 7/02; H01B 13/14; H01B 13/24; B29C 47/02

(52) U.S. Cl. 156/51; 156/178; 156/244.12; 156/52

(57) ABSTRACT

A method and device for the production of flat ribbon cables is disclosed, in which several metallic conductors are provided one next to the other and spaced apart in one or more planes, within a synthetic material sheath. The electrical conductors are placed on a ribbon-shaped base and secured with a curing synthetic material melt, so that the synthetic material film that lies in the gap between a roller and a shape molding causes the metallic electrical conductors to join and combine into one composite product. This intermediate product is then, within the same gap between roller and shape molding, joined and coated with a synthetic material compound in a plastic state with the result that the conductors are ensheathed on all sides.

The invention relates to a method and a device for the production of flat ribbon cables, in which in a synthetic material sleeve several metallic conductors are disposed one next to the other, by laying electrical conductors onto a ribbon-shaped base and securing them in place with a synthetic material melt.

This capability of production of flat ribbon cables is disclosed in FR 2446532 A1. In this patent electrical conductors, already ensheathed in an insulating layer, are placed onto a textile ribbon, into the interspaces between the ensheathed conductors and the ribbon a hot melt is introduced for securing the ensheathed conductors, and the entire combination is drawn through a drawing plate orienting the conductors. Hereby a relatively thick ribbon-form cable is generated such as is demanded today for technical application.

Thin flat ribbon cables are continuously gaining importance in the field of technology, because they can be laid simpler and more clearly than cable harnesses, are of lower weight and their conductors can be better differentiated with uniform thickness and a width adapted to the current to be transmitted, and they can be mounted more simply into an electric network. This is a cable in which, depending on requirement, up to ten, twenty or more conductors are disposed one next to the other preferably equidistantly. In these thin flat ribbon cables metallic bare conductors are ensheathed on all sides by synthetic material.

Produced are such thin flat ribbon cables for example according to the specification of DE 101 03 367 A1 in a two-roller device, in which through the roller gap the bare metallic conductors are guided and in this gap are coated on both sides with a synthetic material compound, which subsequently envelops the individual conductors on all sides. For this purpose onto each of the two rollers the synthetic material compound is applied using the chill-roll method and through the rollers also pressed into the interspaces between the conductors, where the two applied synthetic material layers are joined to form an integral ribbon, the flat ribbon cable, of metallic conductors ensheathed on all sides. The process operation is not simple since the maintenance of an exact central position of the metallic conductors in the center of the generated ribbon is difficult due to the different bulging formations of the synthetic material compounds in front of the roller gap. Moreover, the production device is expensive.

DE 195 34 012 C2 discloses producing a composite material comprised of at least one synthetic material layer on a base with an interspaced layer of an adhesion agent or bonding means by direct extrusion of molten synthetic material, with the adhesion agent or the synthetic material comprising metals. This method is minimally suited for the production of flat ribbon cables.

The invention avoids the disadvantages of prior art. The invention addresses the problem of producing flat ribbon cables using simpler techniques and with readily modifiable tools free of air inclusions and without using bonding means.

The invention comprises in joining a synthetic material film in a gap between a roller and a shape molding with the metallic electric conductors and connecting them to a composite product, that this intermediate product in the same gap between the roller and the shape molding is combined with a synthetic material compound in the plastic state and coated such that the conductors are ensheathed on all sides and form a flat ribbon cable.

Utilizing this process goods free of air inclusions can be produced without problems in simple manner with low machine expenditures. With this process can be fabricated, also free of problems and without machine conversion, goods of any width with any number of conductors.

The sequence of operation here is that onto a film, at a location at which it is already partially wound around the roller, are laid metallic conductors in front of the gap between the roller and the shape molding and that this intermediate product in this gap between the roller and a shape molding is joined together and is coated with a synthetic material compound in the plastic state.

The approach is such that the plastic synthetic material compound is generated in an extruder and the roller, the joining of the conductors as well as the shape molding are disposed on or in the injection head of the extruder.

By “plastic synthetic compound” is here and in the following always understood a “synthetic material compound in the plastic state” such as is obtained from an extruder in the warmed and plastic condition.

To be better able to embed the metallic conductors in the film and to combine the film better with the coating with the plastic synthetic material compound, it can be useful if the film before the approach to a roller is heated to a temperature which promotes the connection or melting-together with the applied synthetic material compound.

The method of the invention can also be applied where a flat ribbon cable is to be produced in which the conductors are disposed in two planes. The operating sequence here is that rollers provided with grooves are employed which leave in each instance between the grooves a gap and that every second conductor is introduced into the roller gap via the groove bottom, the interspaced conductors via the raised portions of the roller.

A significant advantage of this invention is that the production can be very rapidly converted to any conductor numbers and different widths of the flat ribbon cables. A margin trimming taking place after the production of the flat ribbon cable makes possible at predetermined conductor numbers adjusting any desired widths of the flat ribbon cables. But the capability is also given of dividing a generated flat ribbon cable into several flat ribbon cables of lesser conductor number.

In the following the essence of the invention will be explained in further detail in conjunction with embodiment examples shown in the drawing. Therein depict:

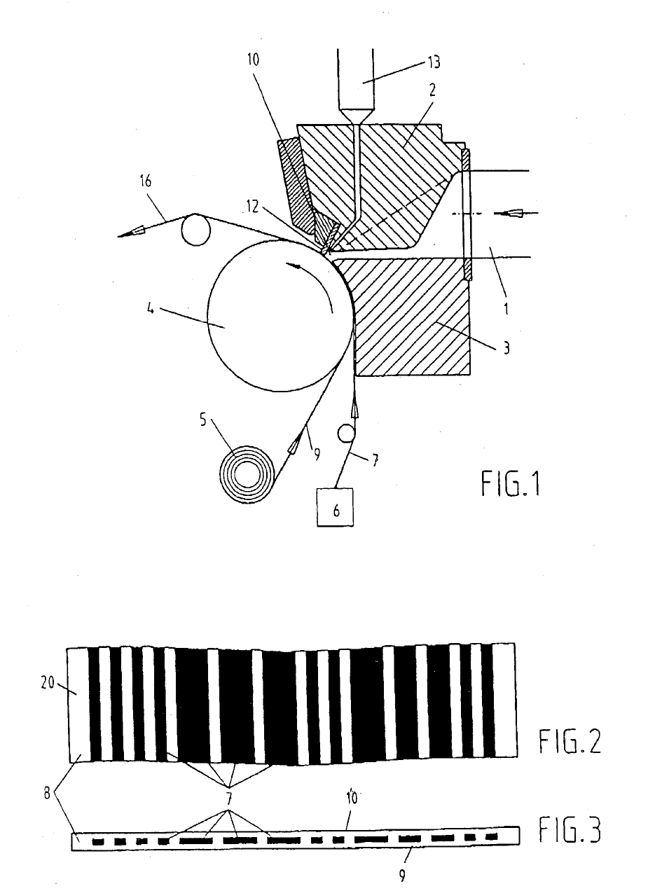

FIG. 1 an injection head, equipped with a roller, of an extruder,

FIG. 2 a plan view of the finished product,

FIG. 3 a cross section through the finished product.

The installation depicted in FIG. 1 for the production of a flat ribbon cable comprises an extruder 1, an injection head structured of the two fixedly disposed injection head portions 2, 3 and the injection head structured of the driven roller 4 as well as a film supply device 5 and a feeding device 6 for the group of conductors 7.

With this installation a flat ribbon cable is produced which is depicted in FIG. 2 in plan view and in FIG. 3 in cross section. In a common synthetic material sheath 8 is disposed the group of conductors 7 in a planar position and parallel to one another. The synthetic material sheath is produced from the synthetic material film 9 and an applied synthetic material coating 10 of film thickness.

The two-part injection head 2, 3 of FIG. 1 comprises a shape molding 12 whose spacing relative to the roller 4 determines the height of the gap between the roller 4 and the shape molding 12 and therewith the thickness of the synthetic material coating 10 applied onto the synthetic material film 9 and the group of conductors 7. A second extruder 13 can be provided to be charged with another extrudate, for example for color marking.

List of Reference Symbols

| | |
|---|---|
| 1 | Extruder |
| 2 | Injection head part |
| 3 | Injection head part |
| 4 | Roller |
| 5 | Film unwinding device |
| 6 | Conductor supply device |
| 7 | Conductor |
| 8 | Synthetic material sheath |
| 9 | Synthetic material film |
| 10 | Synthetic material coating |
| 12 | Shape molding |
| 13 | Second extruder |
| 16 | Flat ribbon cable |
| 20 | Synthetic material compound |

1. Method for the production of flat ribbon cables, in which in a synthetic material sheath several metallic conductors are disposed one next to the other and spaced apart in at least one plane, by placing electric conductors onto a ribbon-shaped base and securing them in position with a curing synthetic material melt, characterized thereby
that the synthetic material film (9) in a gap between a roller (4) and a shape molding (12) are joined with the metallic electric conductors (7) and combined to form a composite product,
that this intermediate product in the same gap between the roller (4) and the shape molding (12) is joined and coated with a synthetic material compound in the plastic state such that the conductors are ensheathed on all sides (7).

2. Method as claimed in claim 1, characterized in
that onto the synthetic material film (9) at a location at which it is already partially wound around the roller (4), before the gap between the roller (4) and the shape molding (12) are placed the metallic conductors (7), and that this intermediate product in this gap between the roller (4) and the shape molding (12) is joined and coated with a synthetic material compound in the plastic state.

3. Method as claimed in claim 1 and 2, characterized in
that the plastic synthetic compound is generated in an extruder (1) and the roller (4), the feeding of the conductors (7) as well as the shape molding (12) is disposed on or in the injection head (2, 3) of the extruder (1).

4. Method as claimed in claim 1, characterized in
that the film (9) before the approach to the roller (4) is heated to a temperature which promotes the joining or the melting-together with the applied synthetic material compound.

5. Method as claimed in claim 1, characterized in
that the margins of the flat ribbon cable (16) after it leaves the roller gap is trimmed and/or that the generated flat ribbon cable (16) is cut into several flat ribbon cables of lesser conductor number.

6. Device for the production of flat ribbon cables, in which in a synthetic material sheath several metallic conductors are disposed one next to the other, characterized in
that it comprises a gap between a roller (4) and a shape molding (12), that it is equipped with means (6) for feeding a synthetic material film (9) as well as with means (6) for feeding the conductors (7) into the gap, and
that means for feeding into the gap a synthetic material compound changing into a cover layer are provided on the side of the conductors (7) facing away from the synthetic material film (9).

7. Device as claimed in claim 6, characterized in
that it is comprised of a driven roller (4) and a stationary block (3), partially encompassing the roller (4), with a shape molding (12) delimiting the roller gap relative to the roller (4),
that the block (3) functions as an injection head of at least one extruder (1) and that it is penetrated by at least one channel leading from the extruder (1) onto the roller surface and shaping the extrudate into a broad stream, and
that the device is provided with a film feed as well as a feeding device for the group of parallel extending conductors (7) and a draw-off device for the flat ribbon cable (16).

8. Device as claimed in claim 6, characterized in
that the roller (4) of the injection head is equipped with heating or cooling means.

9. Device as claimed in claim 6, characterized in
that the film supply device or a length of path succeeding it through which travels the wound-off film (9)is equipped with a heating means of the film (9).

10. Device as claimed in one of the preceding device claims, characterized in
that succeeding the roller gap is a cutting installation for trimming the margins of the flat ribbon cable (16) or for the division of the generated flat ribbon cable (16) into several flat ribbon cables of lesser conductor number.
